(19) United States
(12) Patent Application Publication
(10) Pub. No.: US 2026/0160878 A1
(43) Pub. Date: Jun. 11, 2026

(54) METHOD AND APPARATUS WITH RADAR SIGNAL PROCESSING

(71) Applicant: Samsung Electronics Co., Ltd., Suwon-si (KR)

(72) Inventors: Seung Tae KHANG, Suwon-si (KR); Ghoo KIM, Suwon-si (KR); Jong-Sok KIM, Suwon-si (KR); Jinyong JEON, Suwon-si (KR)

(73) Assignee: Samsung Electronics Co., Ltd., Suwon-si (KR)

(21) Appl. No.: 19/206,406

(22) Filed: May 13, 2025

(30) Foreign Application Priority Data
Dec. 11, 2024 (KR) 10-2024-0183909

(51) Int. Cl. G01S 13/58; G01S 7/35; G01S 13/931

(52) U.S. Cl. CPC G01S 13/584; G01S 7/356; G01S 13/931; G01S 2013/93271

(57) ABSTRACT

A processor-implemented method including generating an angular spectrum corresponding to a target point, based on a radar signal received through an antenna array of a radar sensor, identifying a target angle of a peak signal corresponding to a maximum peak responsive to a maximum peak of the angular spectrum satisfying a defined condition, updating the angular spectrum by subtracting a target angular spectrum generated based on the peak signal from the angular spectrum, and generating multi-angle information of the target point, the multi-angle information including one or more target angles, the generating the multi-angle information including iteratively performing additional identifying of the target angle and additional updating of the angular spectrum until an iteratively derived maximum peak of an iteratively updated angular spectrum does not satisfy the defined condition.

### CROSS-REFERENCE TO RELATED APPLICATIONS

This application claims the benefit under 35 USC § 119 (a) of Korean Patent Application No. 10-2024-0183909, filed on Dec. 11, 2024, in the Korean Intellectual Property Office, the entire disclosure of which is incorporated herein by reference for all purposes.

### BACKGROUND

### 1. Field

The following description relates to a method and apparatus with radar signal processing.

### 2. Description of Related Art

An advanced driver-assistance system (ADAS) is a system that supports driving to improve drivers' safety and convenience and to avoid dangerous situations by using sensors mounted inside or outside a vehicle. The sensors that are used in an ADAS may include, for example, a camera, an infrared sensor, an ultrasonic sensor, a light detection and ranging (lidar), and a radar.

The demands being placed on models that perform functions of recognizing and tracking objects are increasing for autonomous vehicles or security monitoring devices. An autonomous vehicle may represent the surroundings as point clouds by using information collected by a radar or a lidar sensor.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating an angular spectrum corresponding to a target point, based on a radar signal received through an antenna array of a radar sensor, identifying a target angle of a peak signal corresponding to a maximum peak responsive to a maximum peak of the angular spectrum satisfying a defined condition, updating the angular spectrum by subtracting a target angular spectrum generated based on the peak signal from the angular spectrum, and generating multi-angle information of the target point, the multi-angle information including one or more target angles, the generating the multi-angle information including iteratively performing additional identifying of the target angle and additional updating of the angular spectrum until an iteratively derived maximum peak of an iteratively updated angular spectrum does not satisfy the defined condition.

The generating the angular spectrum may include determining the target point by performing range fast Fourier transform (FFT) and Doppler FFT, based on the radar signal and generating the angular spectrum corresponding to the target point, based on the radar signal.

The generating the angular spectrum may include generating the angular spectrum corresponding to the target point by performing digital one or more of beamforming (DBF), averaged periodograms, and angle FFT, based on the radar signal.

The updating the angular spectrum may include generating the peak signal corresponding to the maximum peak, based on signal characteristics of the maximum peak, generating the target angular spectrum, based on the peak signal, and updating the angular spectrum by subtracting the target angular spectrum from the angular spectrum.

The target point may include range information and velocity information and the method may also include generating point cloud data including range information, velocity information, and angle information, based on the multi-angle information of the target point.

The target point may include a plurality of target points and the method may further include performing the generating the angular spectrum, the identifying the target angle, the updating the angular spectrum, and the generating the multi-angle information on each of the plurality of target points and generating point cloud data, based on multi-angle information of each of the plurality of target points.

The generating the multi-angle information of the target point may include generating, if a maximum peak of a latest updated angular spectrum does not satisfy the defined condition, the multi-angle information including the target angle and at least one additional target angle respectively identified from at least one updated angular spectrum being updated before a latest iteration of the iterative performing of the additional identifying and the additional updating.

The defined condition may include a condition where a radar cross-section (RCS) value represented by the maximum peak of the angular spectrum exceeds a threshold.

The threshold may be determined based on a minimum RCS value of a specified detected object.

The threshold may be further determined by applying a weight to the minimum RCS value.

In a general aspect, here is provided an electronic device including processors configured to execute instructions, a memory storing the instructions, and an execution of the instructions configures the processors to generate an angular spectrum corresponding to a target point, based on a radar signal received through an antenna array of a radar sensor, identify a target angle of a peak signal corresponding to a maximum peak responsive to a maximum peak of the angular spectrum satisfying a defined condition, update the angular spectrum by subtracting a target angular spectrum generated based on the peak signal from the angular spectrum, and generate multi-angle information of the target point, the multi-angle information including one or more target angles, the generating the multi-angle information including iteratively performing additional identifying of the target angle and additional updating of the angular spectrum until an iteratively derived maximum peak of an iteratively updated angular spectrum does not satisfy the defined condition.

The generating the angular spectrum corresponding to the target point, based on the radar signal received through the antenna array of the radar sensor may include determining the target point by performing range fast Fourier transform (FFT) and Doppler FFT, based on the radar signal and generating the angular spectrum corresponding to the target point, based on the radar signal.

The generating the angular spectrum may include generating the angular spectrum corresponding to the target point by performing one or more of digital beamforming (DBF), averaged periodograms, and angle FFT, based on the radar signal.

The updating the angular spectrum may include generating the peak signal corresponding to the maximum peak, based on signal characteristics of the maximum peak, generating the target angular spectrum, based on the peak signal, and updating the angular spectrum by subtracting the target angular spectrum from the angular spectrum.

The target point may include range information and velocity information and the processors may be further configured to generate point cloud data including range information, velocity information, and angle information, based on the multi-angle information of the target point.

The target point may include a plurality of target points and the processors may be further configured to perform the generating the angular spectrum, the identifying the target angle, the updating the angular spectrum, and the generating the multi-angle information on each of the plurality of target points and generate point cloud data, based on multi-angle information of each of the plurality of target points.

The generating the multi-angle information of the target point may include generating if a maximum peak of a latest updated angular spectrum does not satisfy the defined condition, the multi-angle information including the target angle and at least one additional target angle respectively identified from at least one updated angular spectrum being updated before a latest iteration of the iterative performing of the additional identifying and the additional updating.

A vehicle may include the electronic device and the radar sensor.

The defined condition may include a condition where a radar cross-section (RCS) value represented by the maximum peak of the angular spectrum exceeds a threshold.

The threshold may be determined based on a minimum RCS value of a specified detected object.

Other features and aspects will be apparent from the following detailed description, the drawings, and the claims.

### BRIEF DESCRIPTION OF THE DRAWINGS

FIGS. 1A and 1B illustrate example methods of recognizing a surrounding environment through radar signal processing according to one or more embodiments.

FIG. 2 illustrates an example electronic device according to one or more embodiments.

FIG. 3 illustrates an example method with radar signal processing according to one or more embodiments.

FIG. 4 illustrates an example method of updating an angular spectrum according to one or more embodiments.

FIG. 5 illustrates an example method of generating point cloud data according to one or more embodiments.

FIG. 6 illustrates example operations of methods of generating multi-angle information for a large object at a short range according to one or more embodiments.

FIG. 7 illustrates example operations of methods of generating multi-angle information for objects having different RCS values according to one or more embodiments.

FIG. 8 illustrates example operations of methods of generating multi-angle information for a large object at a short range using a relatively low angular resolution radar sensor according to one or more embodiments.

FIG. 9 illustrates example operations of methods of generating multi-angle information for an object at an extended range according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

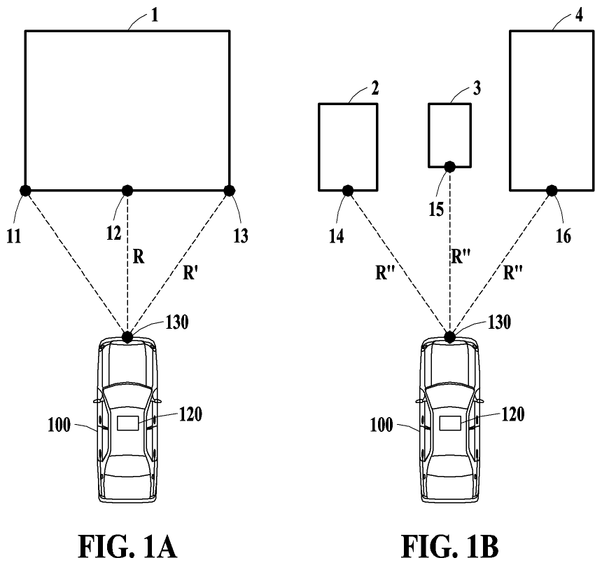

FIGS. 1A and 1B illustrate example methods of recognizing a surrounding environment through radar signal processing according to one or more embodiments.

Referring to FIGS. 1A and 1B, in a non-limiting example, an electronic device 120 for processing a radar signal may detect information (e.g., a range, velocity, or direction) about an object 1, 2, 3, or 4 outside the electronic device 120 by analyzing a radar signal received from a radar sensor 130.

In an example, a vehicle 100 may detect the information (e.g., a range, velocity, or direction) about the object 1, 2, 3, or 4 outside the vehicle 100 by analyzing a radar signal received from the radar sensor 130. In an example, the vehicle 100 may include the electronic device 120 for processing a radar signal received from the radar sensor 130. The radar sensor 130 may be positioned inside or outside the electronic device 120. The electronic device 120 may detect the information about the objects 1, 2, 3, or 4 by using data collected from other sensors (e.g., an image sensor) mounted on the vehicle 100 together with a radar signal received from the radar sensor 130.

The vehicle 100 may perform adaptive cruise control (ACC), autonomous emergency braking (AEB), blind spot detection (BSD), and/or lane change assistance (LCA), based on a range from the object 1, 2, 3, or 4 detected by the electronic device 120. In an example, the electronic device 120 may generate a surrounding map in addition to range detection. The surrounding map may be a map that shows the position of various objects around the electronic device 120 (or the vehicle 100), such as the objects 1, 2, 3, or 4. Those objects may be dynamic objects, such as vehicles and people that move, or static objects, such as guardrails and traffic lights that tend to remain in place, in the background.

The electronic device 120 may generate direction of arrival (DOA) information by analyzing a radar signal received from the radar sensor 130. The DOA information may represent information indicating a direction in which a radar signal reflected from the object 1, 2, 3, or 4 is received. The electronic device 120 may identify a direction in which the object 1, 2, 3, or 4 exists relative to the radar sensor 130 by using the DOA information. The DOA information may be used to generate radar scan data and the surrounding map.

The electronic device 120 may detect points regarding any static or dynamic objects in the surrounding environment based on a radar signal received from the radar sensor 130. Each point may include range information and velocity information. The electronic device 120 may generate the DOA information of the points. The electronic device 120 may generate point cloud data about the surrounding environment by using the DOA information of the points. The point cloud data may be used to control the vehicle 100 equipped with the electronic device 120. For example, the control of the vehicle 100 may include velocity and/or steering control, such as adaptive cruise control (ACC), automated emergency braking (AEB), blind spot detection (BSD), or lane change assist (LCA), of the vehicle 100. A control system of the vehicle 100 may control the vehicle 100 by directly or indirectly using the point cloud data.

The points that are detected from the radar signals may include, for example, radar signals from multiple angles if the radar sensor 130 has a relatively high angular resolution. For example, estimating a single angle of a radar signal with the highest intensity among the radar signals to generate the DOA information of the points may not be able to readily generate the point cloud data that would include sufficiently diverse information despite a high angular resolution of the radar sensor 130. That is, estimating multiple angles by removing signals, such as noise or sidelobes under a certain level, from the radar signals to generate the DOA information of the points may not readily distinguish peaks of signals from the sidelobes if a radar cross-section (RCS) value (or a reflection coefficient) of each radar signal is different.

Referring to FIG. 1A, the electronic device 120 may detect a point corresponding to a large object 1 (e.g., points 11, 12, and 13), based on a radar signal received through the radar sensor 130. In an example, the electronic device 120 may detect points by analyzing radar signals by distance sections depending on range resolution of the radar sensor 130. If the large object 1 is at a short range, although an actual range R between the radar sensor 130 and the point 12 of the large object 1 is different from an actual range R′ between the radar sensor 130 and the point 13, a range detected from each point may belong to the same actual distance between the vehicle 100 and the large object 1. Accordingly, different points of the large object 1 at a short range may be detected as a single point with the same range information or as a few points that may not reflect the actual range information. In addition, in an instance in which the large object 1 has a varying shape, including portions that extend from the large object 1 to the vehicle (i.e., a peak), an actual peak of the large object 1 may not be readily distinguished because of a large RCS deviation of a radar signal reflected at each point.

Referring to FIG. 1B, the electronic device 120 may detect points corresponding to the objects 2, 3, and 4, based on radar signals received through the radar sensor 130. An RCS deviation between the radar signals reflected from the objects 2, 3, and 4 around the radar sensor 130 may be small or large. Specifically, if the objects 2, 3, and 4 (or points 14, 15, and 16) having different RCS values are at substantially the same (or similar) range R″ from the radar sensor 130, peaks corresponding respectively to the objects 2, 3, and 4 may not be readily identified. That is, points 14, 15, and 16, may be interpreted to be a single object, possibly at a single distance from the vehicle 100, instead of separate objects 2, 3, and 4.

In an example, a method of generating a point cloud of a plurality of points having different angle information that generates multi-angle information of the points detected relative to the large object 1 at a short range may be provided. In an example, a method of generating a point cloud of a plurality of points having different angle information corresponding respectively to the objects 2, 3, and 4 by generating multi-angle information of the points detected relative to the objects 2, 3, and 4 having a large RCS deviation may also be provided.

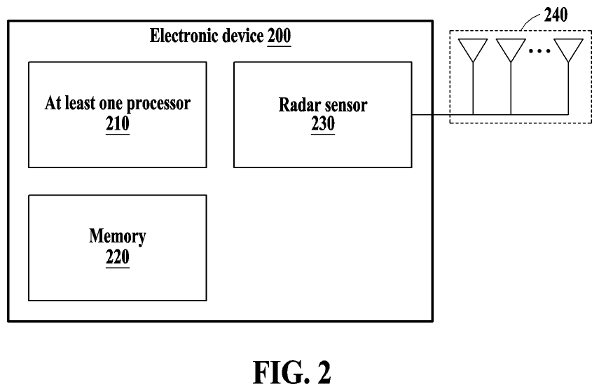

FIG. 2 illustrates an example electronic device according to one or more embodiments.

Referring to FIG. 2, in a non-limiting example, an electronic device 200 (e.g., the electronic device 120 of FIGS. 1A and 1B) may include at least one processor (hereinafter, the processor) 210 including processing circuitry, a memory 220 including one or more storage media storing the instructions, and a radar sensor 230 (e.g., the radar sensor 130 of FIGS. 1A and 1B). When the instructions are individually or collectively executed by the processor 210, they may cause the electronic device 200 to perform at least some of the operations described with reference to FIGS. 1A to 5 of the present disclosure. For example, the vehicle 100 of FIGS. 1A and 1B may include the electronic device 200.

The electronic device 200 may include a communicator (not shown) that is connected to the processor 210 and the memory 220 to transmit and receive data. The communicator may be connected to another external device and may transmit and receive data to and from the external device. Hereinafter, transmitting and receiving “A” may refer to transmitting and receiving “information or data indicating A”.

The communicator may be implemented as circuitry in the electronic device 200. For example, the communicator may include an internal bus and an external bus. For another example, the communicator may be an element that connects the electronic device 200 to the external device. The communicator may be an interface. The communicator may receive data from the external device and may transmit the data to the processor 210 and the memory 220.

The processor 210 may process data received by the communicator, data stored in the memory 220, and radar signals received through the radar sensor 230. The “processor” may be a data processing device implemented as hardware having circuitry with a physical structure for executing desired operations. For example, the desired operations may include code or instructions included in a program.

The memory 220 may include computer-readable instructions. The processor 210 may be configured to execute computer-readable instructions, such as those stored in the memory 220, and through execution of the computer-readable instructions, the processor 210 is configured to perform one or more, or any combination, of the operations and/or methods described herein.

The processor 210 may be configured to execute programs or applications to configure the processor 210 to control the electronic apparatus 200 to perform one or more or all operations and/or methods involving the resolution of a deadlock state and resuming a task, and may include any one or a combination of two or more of, for example, a microprocessor, a central processing unit (CPU), a graphics processing unit (GPU), a processor core, a multi-core processor, a multiprocessor, an application-specific integrated circuit (ASIC), or a field-programmable gate array (FPGA).

The processor 210 may control other components (e.g., hardware or software components) of the electronic device 200 and may perform various types of data processing or operations. As at least part of data processing or calculation, the processor 210 may store commands or data received from another component (e.g., the communicator or the radar sensor 230) in at least a portion of the memory 220, may process the commands or data stored in the memory 220, and may store result data in the memory 220. The operations performed by the processor 210 may be substantially the same as the operations of the electronic device 200.

The memory 220 may store information necessary for the processor 210 to perform a processing operation. The memory 220 (or one or more storage media included in the memory 220) may store instructions executed by the processor 210 and may store related information while software or a program is executed by the electronic device 200. For example, the memory 220 may include one or more memories, which are volatile and/or non-volatile memories known in the field, like random-access memory (RAM), dynamic RAM (DRAM), static RAM (SRAM), non-volatile RAM (NVRAM), persistent memory (PMEM), magneto-resistive RAM (MRAM), high bandwidth memory (HBM), or 3DXPoint.

The electronic device 200 may be connected to an external memory through the communicator. For example, the external memory may include one or more volatile memories, non-volatile memories and RAM, flash memories, hard disk drives, and optical disc drives. The external memory may store an instruction set (e.g., software) for operating the electronic device 200. The instruction set for operating the electronic device 200 may be executed by the processor 210.

The radar sensor 230 may radiate a radar signal to the outside of the radar sensor 230. The radiated radar signal may be reflected by an object (e.g., the object 1, 2, 3, or 4 of FIGS. 1A and 1B). The radar sensor 230 may receive the radar signal reflected by the object (e.g., the object 1, 2, 3, or 4 of FIGS. 1A and 1B).

The radar sensor 230 may include an antenna array 240. For example, the radar sensor 230 may represent a sensor circuit including the antenna array 240. The radar sensor 230 may transmit a radar signal through the antenna array 240. The radar sensor 230 may receive a radar signal through the antenna array 240. The antenna array 240 may include a plurality of antenna elements. Multiple input multiple output (MIMO) may be implemented through the plurality of antenna elements.

The processor 210 may generate and use information on an object based on a radar signal. For example, the processor 210 may perform range fast Fourier transform (FFT), Doppler FFT, constant false alarm rate detection (CFAR), and DOA estimation, and may obtain the information on the object, such as a range, a velocity, and a direction, based on the radar signal. The information on such an object may be provided for various applications, such as ACC, AEB, BSD, and LCA.

In an example, the electronic device 200 is a component that manages an electronic system of a vehicle (e.g., the vehicle 100 of FIGS. 1A and 1B) and may represent an electronic control unit (ECU) of the vehicle, a component included in the electronic control unit, or a component directly (e.g., wired) or wirelessly connected to the electronic control unit.

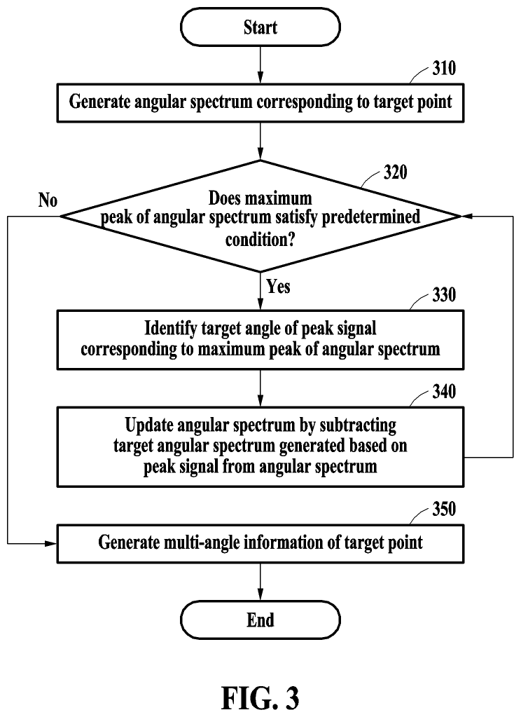

FIG. 3 illustrates an example method with radar signal processing according to one or more embodiments.

Referring to FIG. 3, in a non-limiting example, operations 310 to 350 may be performed by an electronic device (e.g., the electronic device 120 of FIGS. 1A and 1B or the electronic device 200 of FIG. 2). The electronic device may include one or more of the components of the electronic device 120 or 200 described in FIGS. 1A to 2. For example, the electronic device may include at least one processor (e.g., the at least one processor 210 of FIG. 2), a memory (e.g., the memory 220 of FIG. 2), and a radar sensor (e.g., the radar sensor 130 of FIGS. 1A and 1B or the radar sensor 230 of FIG. 2). The radar sensor of the electronic device may include an antenna array (e.g., the antenna array 240 of FIG. 2).

In an example, in operation 310, the electronic device may generate an angular spectrum corresponding to a target point, based on a radar signal received through the antenna array of the radar sensor.

The electronic device may determine the target point by performing range FFT and Doppler FFT, based on the radar signal. The target point may include range information and velocity information.

The electronic device may generate the angular spectrum corresponding to the target point, based on the radar signal. For example, the electronic device may generate the angular spectrum corresponding to the target point by performing digital beamforming (DBF), averaged periodograms, or angle FFT, based on the radar signal.

In an example, in operation 320, the electronic device may determine whether a maximum peak of the angular spectrum corresponding to the target point satisfies a defined condition.

The defined condition may include a condition where an RCS value represented by the maximum peak of the angular spectrum exceeds (or is greater than or equal to) a threshold. The threshold may be determined based on a minimum RCS value of specified detected objects.

The electronic device may pre-specify the types of detected objects, such as, for example, a bus, a truck, a utility vehicle, or other large vehicles, a motorcycle, a bicycle, a passenger car, or other small vehicles, a pedestrian, a street tree, or a guardrail, but examples are not limited thereto. The electronic device may determine the threshold of the defined condition based on the minimum RCS value among RCS values of the specified detected objects. For example, the electronic device may determine the threshold by applying a weight (e.g., a value between 0.3 and 0.9) to the minimum RCS value of the specified detected objects. Accordingly, a reliability of maximum peak detection may be improved despite an RCS deviation between objects of different sizes (or objects with different RCS values).

In an example, in operation 330, the electronic device may identify a target angle of a peak signal corresponding to the maximum peak if the maximum peak of the angular spectrum corresponding to the target point satisfies the defined condition.

The electronic device may store the identified target angle as multi-angle information of the target point.

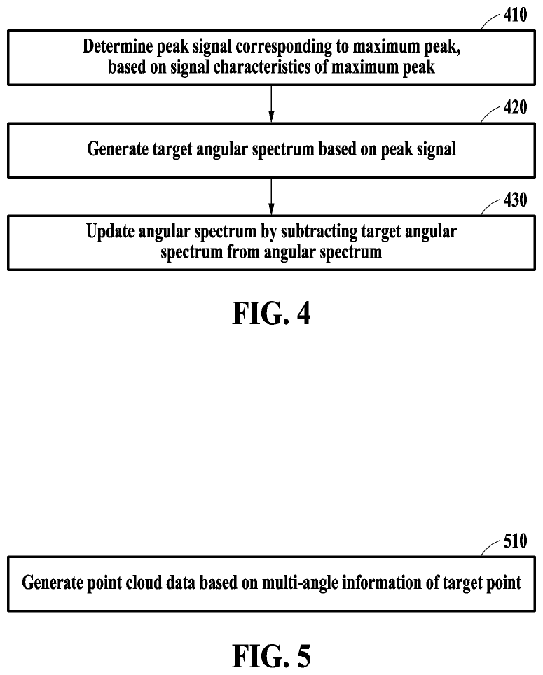

In an example, in operation 340, the electronic device may update the angular spectrum by subtracting a target angular spectrum generated based on the peak signal from the angular spectrum corresponding to the target point. The method for updating the angular spectrum is described in greater detail below with reference to FIG. 4.

In an example, in operation 350, the electronic device may generate the multi-angle information of the target point, including one or more target angles identified by iteratively identifying the target angle and updating the angular spectrum until the maximum peak of the updated angular spectrum does not satisfy the defined condition.

For example, for ease of description, the maximum peak when operations 310 to 340 are performed once may be referred to as a first maximum peak, a peak signal corresponding to the first maximum peak may be referred to as a first peak signal, a target angle of the first peak signal may be referred to as a first target angle, and a target angular spectrum generated based on the first peak signal may be referred to as a first target angular spectrum. The electronic device may update the angular spectrum by subtracting the first target angular spectrum from the angular spectrum in operation 340.

The electronic device may determine whether a second maximum peak of the updated angular spectrum satisfies the defined condition. The electronic device may identify a second target angle of a second peak signal corresponding to the second maximum peak if the second maximum peak of the updated angular spectrum satisfies the defined condition. The electronic device may store the identified second target angle as the multi-angle information of the target point together with the first target angle identified when performing operations 310 to 340 once. The electronic device may update the angular spectrum again by subtracting a second target angular spectrum generated based on the second peak signal from the updated angular spectrum. The electronic device may iteratively perform operations 320 to 340 until a maximum peak of a newly updated angular spectrum does not satisfy the defined condition.

After iteratively performing operations 320 to 340 a certain number of times, again in operation 320, the electronic device may determine that the maximum peak of the updated angular spectrum does not satisfy the defined condition through the latest iteration (or the current iteration) of identifying the target angle and updating the angular spectrum, that is, operations 320 of determining whether the maximum peak of the angular spectrum (or the updated angular spectrum) satisfies the defined condition, operation 330 of identifying the target angle, and operation 340 of updating the angular spectrum. The electronic device may store one or more target angles as the multi-angle information of the target point through the iterations of the certain number of times, that is, up to the latest iteration of identifying the target angle and updating the angular spectrum.

If the maximum peak of the angular spectrum updated by the latest iteration of identifying the target angle and updating the angular spectrum does not satisfy the defined condition, the electronic device may generate the multi-angle information of the target point, including the target angle (or the first target angle) and at least one target angle (e.g., the second target angle) identified respectively from at least one angular spectrum updated before the latest iteration. For example, one or more of these target angles from the iterations of identifying the target angle and updating the angular spectrum may be referred to as data points, representing portions of the totality of the multi-angle information. Thus each iteration up to and including a final iteration when the condition is no longer met may be stored as a portion within the multi-angle information.

FIG. 4 illustrates an example method of updating an angular spectrum according to one or more embodiments.

Referring to FIG. 4, in a non-limiting example, operations 410 to 430 described below may be performed by an electronic device (e.g., the electronic device 120 of FIGS. 1A and 1B or the electronic device 200 of FIG. 2). The electronic device may include one or more of the components of the electronic device 120 or 200 described in FIGS. 1A to 2. For example, the electronic device may include at least one processor (e.g., the at least one processor 210 of FIG. 2), a memory (e.g., the memory 220 of FIG. 2), and a radar sensor (e.g., the radar sensor 130 of FIGS. 1A and 1B or the radar sensor 230 of FIG. 2). The radar sensor of the electronic device may include an antenna array (e.g., the antenna array 240 of FIG. 2).

In an example, operation 340 of updating the angular spectrum of FIG. 3 may include operations 410 to 430.

As described above with reference to FIG. 3, the electronic device may determine a target point by performing range FFT and Doppler FFT, based on a radar signal received through an antenna array of a radar sensor. The target point may include range information and velocity information.

A radar signal input to an nth antenna element among a plurality of antenna elements of the antenna array at the target point may be expressed by Equation 1.

$${s}_{n} = {\sum }_{k = 1}^{{N}_{Angle}} {α}_{k} {e}^{- j \frac{2 π}{λ} {x}_{n} sin {θ}_{k}} \qquad Equation 1$$

In equation 1, N_{Angle} denotes the number of radar signals reflected and received from the target point, αₖ denotes a relative RCS value of each radar signal reflected and received from the target point, λ denotes a wavelength of an operating frequency of the radar sensor, xₙ denotes a range between the nth antenna element and the target point, and θₖ denotes an angle of the radar signal received by the nth antenna element.

In an example, the electronic device may generate an angular spectrum corresponding to the target point, based on radar signals input to the plurality of antenna elements. For example, the electronic device may generate an angular spectrum Spectrum₀(θ) corresponding to the target point by performing DBF, averaged periodograms (e.g., Bartlett methods), or angle FFT, based on the radar signals respectively input to the plurality of antenna elements of the antenna array as shown in Equation 1.

The electronic device may determine whether a maximum peak of the angular spectrum satisfies a defined condition. The electronic device may identify a target angle of a peak signal corresponding to the maximum peak if the maximum peak of the angular spectrum satisfies the defined condition. The electronic device may store the identified target angle as multi-angle information of the target point.

The multi-angle information of the target point may include one or more target angles θₗ and may be expressed by Equation 2.

$${θ}_{l} = {max}_{θ} \vert {Spectrum}_{l - 1} ( θ ) \vert , l = 1 , 2 , … , {N}_{Angle} \qquad Equation 2$$

In an example, in operation 410, the electronic device may determine the peak signal corresponding to the maximum peak, based on the signal characteristics of the maximum peak of the angular spectrum.

The signal characteristics of the maximum peak may include a magnitude, a phase, and an angle of the maximum peak. A peak signal S_{Ext,l,n} corresponding to the maximum peak input to the nth antenna element may be expressed by Equation 3.

$${S}_{Ext , l , n} = {α}_{Ext , l} {e}^{- j \frac{2 π}{λ} {x}_{n} sin {θ}_{l}} \qquad Equation 3$$

In equation 3, α_{Ext,l} denotes the maximum peak, which is a relative RCS of each radar signal reflected and received from the target point and may be expressed by Equation 4.

$${α}_{Ext , l} = \vert {Spectrum}_{l - 1} ( {θ}_{l} ) \vert {e}^{j ∠ ( {Spectrum}_{l - 1} ( {θ}_{l} ) )} \qquad Equation 4$$

In an example, in operation 420, the electronic device may generate a target angular spectrum based on the peak signal corresponding to the maximum peak of the angular spectrum.

The electronic device may generate a target angular spectrum Spectrum_{Ext,l}(θ) by performing DBF, averaged periodograms, or angle FFT, based on the peak signal corresponding to the maximum peak, input to the plurality of antenna elements.

In an example, in operation 430, the electronic device may update the angular spectrum by subtracting the target angular spectrum from the angular spectrum corresponding to the target point.

When operations 410 to 430 are performed once, an angular spectrum updated by subtracting the target angular spectrum Spectrum_{Ext,1}(θ) generated based on the peak signal from an angular spectrum Spectrum₀(θ) corresponding to the target point may be expressed by Equation 5.

$${Spectrum}_{1} ( θ ) = {Spectrum}_{0} ( θ ) - {Spectrum}_{Ext , 1} ( θ ) , \qquad Equation 5$$

As described above with reference to FIG. 3, the electronic device may iteratively perform identifying the target angle and updating the angular spectrum until the maximum peak of the updated angular spectrum does not satisfy the defined condition. The defined condition may include a condition where an RCS value represented by the maximum peak of the angular spectrum exceeds (or is greater than or equal to) a threshold β. The method of updating the angular spectrum may be expressed by Equation 6.

$${Spectrum}_{l} ( θ ) = {Spectrum}_{l - 1} ( θ ) - {Spectrum}_{Ext , l} ( θ ) , l = 1 , 2 , … , {N}_{Angle} \qquad Equation 6$$

The electronic device may terminate the iterations if the maximum peak of the angular spectrum updated through the latest iteration of identifying the target angle and updating the angular spectrum does not satisfy the defined condition, which is |Spectrumₗ₋₁(θₗ)|<β.

FIG. 5 illustrates an example method of generating point cloud data according to one or more embodiments.

Referring to FIG. 5, in a non-limiting example, operation 510 described below may be performed by an electronic device (e.g., the electronic device 120 of FIGS. 1A and 1B or the electronic device 200 of FIG. 2). The electronic device may include one or more of the components of the electronic device 120 or 200 described in FIGS. 1A to 2. For example, the electronic device may include at least one processor (e.g., the at least one processor 210 of FIG. 2), a memory (e.g., the memory 220 of FIG. 2), and a radar sensor (e.g., the radar sensor 130 of FIGS. 1A and 1B or the radar sensor 230 of FIG. 2). The radar sensor of the electronic device may include an antenna array (e.g., the antenna array 240 of FIG. 2).

In an example, in operation 510 may be performed after operation 350 of generating the multi-angle information of the target point of FIG. 3.

In an example, in operation 510, the electronic device may generate the point cloud data based on the multi-angle information of the target point.

The target point may include range information and velocity information. The multi-angle information of the target point may include one or more angle information, or information from one or more angles, of the target point.

The electronic device may generate the point cloud data, including range information, velocity information, and angle information, based on the multi-angle information of the target point. The electronic device may expand a single target point to points having different angle information (e.g. a target angle).

The electronic device may determine a plurality of target points by performing range FFT and Doppler FFT, based on a radar signal received through an antenna array of a radar sensor. In other words, the target point may include the plurality of target points. The electronic device may perform generating an angular spectrum, identifying the target angle, updating the angular spectrum, and generating the multi-angle information (e.g., operations 310 to 350 of FIG. 3) on each of the plurality of target points. The electronic device may generate the multi-angle information for each of the plurality of target points. The electronic device may generate the point cloud data based on the multi-angle information of each of the plurality of target points.

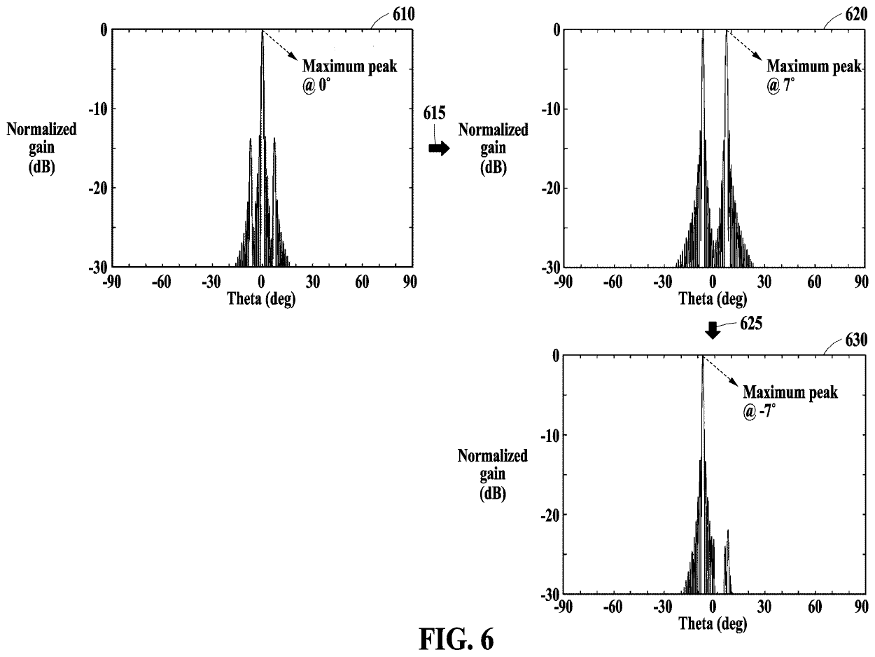

With respect to FIGS. 6 to 9, as discussed in greater detail below, an electronic device (e.g., the electronic device 120 of FIGS. 1A and 1B or the electronic device 200 of FIG. 2), according to an embodiment, may perform one or more of the operations described above with reference to FIGS. 1A to 5. The electronic device may include at least some of the components of the electronic device 120 or 200 described in FIGS. 1A to 2. For example, the electronic device may include at least one processor (e.g., the at least one processor 210 of FIG. 2), a memory (e.g., the memory 220 of FIG. 2), and a radar sensor (e.g., the radar sensor 130 of FIGS. 1A and 1B or the radar sensor 230 of FIG. 2). The radar sensor of the electronic device may include an antenna array (e.g., the antenna array 240 of FIG. 2).

FIG. 6 illustrates example operations of methods of generating multi-angle information for a large object at a short range according to one or more embodiments.

Referring to FIG. 6, in non-limiting examples, a process of generating multi-angle information for a large object at a short range is illustrated through manipulations of the input from the radar sensor as angular spectrum graphs 610, 620, and 630. For example, referring to FIG. 1A, if the large object 1 is at a short range from a radar sensor (or an antenna array of the radar sensor), the different points 11, 12, and 13 of the large object 1 may be detected as a single target point.

In an example, as illustrated in graph 610, the electronic device may generate an angular spectrum corresponding to a target point based on a radar signal received through the antenna array of the radar sensor. The electronic device may determine whether a first maximum peak of the angular spectrum corresponding to the target point satisfies a defined condition. The electronic device may identify a first target angle 0° of a first peak signal corresponding to the first maximum peak if the first maximum peak of the angular spectrum corresponding to the target point satisfies the defined condition.

In an example, as illustrated in graph 620, an updated angular spectrum obtained through step 615 which may be performed by the electronic device subtracting a first target angular spectrum generated based on the first peak signal from the angular spectrum corresponding to the target point. The electronic device may determine whether a second maximum peak of the updated angular spectrum satisfies the defined condition. The electronic device may identify a second target angle 7° of a second peak signal corresponding to the second maximum peak if the second maximum peak of the updated angular spectrum satisfies the defined condition.

In an example, as illustrated in graph 630, an updated angular spectrum obtained through step 625 which may be performed by the electronic device subtracting a second target angular spectrum generated based on the second peak signal from the updated angular spectrum 620. The electronic device may determine whether a third maximum peak of the angular spectrum updated again satisfies the defined condition. The electronic device may identify a third target angle −7° of a third peak signal corresponding to the third maximum peak if the third maximum peak of the angular spectrum updated again satisfies the defined condition.

The electronic device may generate multi-angle information of the target point, including at least the first target angle, the second target angle, and the third target angle. The electronic device may generate point cloud data, including range information, velocity information, and angle information, based on the multi-angle information of the target point. The electronic device may expand a single target point of the large object 1 to the points 11, 12, and 13 having different angle information.

The electronic device may iteratively perform identifying the target angle and updating the angular spectrum until a maximum peak of the angular spectrum updated again does not satisfy the defined condition.

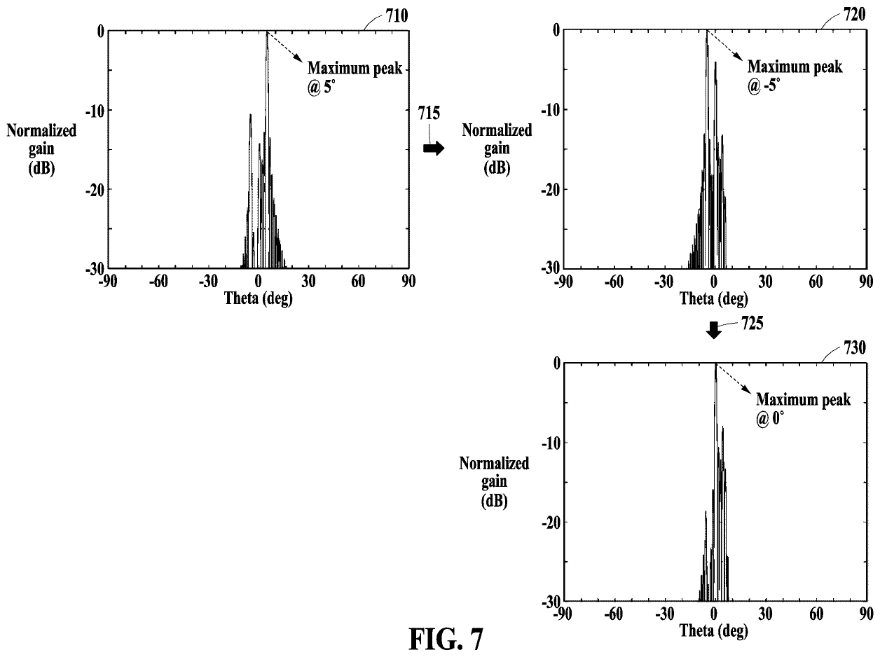

FIG. 7 illustrates example operations of methods of generating multi-angle information for objects having different RCS values according to one or more embodiments.

Referring to FIG. 7, in a non-limiting example, a process of generating multi-angle information for objects having different RCS values is illustrated through manipulations of the input from the radar sensor as angular spectrum graphs 710, 720, and 730. For example, referring FIG. 1B, the RCS deviation between the radar signals reflected from the objects 2, 3, and 4 may be small or large. If the objects 2, 3, and 4 (or the points 14, 15, and 16) having different RCS values are at substantially the same (or similar) range from the radar sensor, peaks corresponding respectively to the objects 2, 3, and 4 may not be readily identified.

In an example, as illustrated in graph 710, the electronic device may generate an angular spectrum corresponding to a target point based on a radar signal received through the antenna array of the radar sensor. The electronic device may identify a first target angle 5° of a first peak signal corresponding to the first maximum peak if the first maximum peak of the angular spectrum corresponding to the target point satisfies the defined condition.

In an example, as illustrated in graph 720, an updated angular spectrum obtained through step 715 which may be performed by the electronic device subtracting a first target angular spectrum generated based on the first peak signal from the angular spectrum corresponding to the target point. The electronic device may identify a second target angle −5° of a second peak signal corresponding to the second maximum peak if the second maximum peak of the updated angular spectrum satisfies the defined condition.

In an example, as illustrated in graph 730, an updated angular spectrum obtained through step 725 which may be performed by the electronic device subtracting a second target angular spectrum generated based on the second peak signal from the updated angular spectrum 720. The electronic device may identify a third target angle 0° of a third peak signal corresponding to the third maximum peak if the third maximum peak of the angular spectrum updated again satisfies the defined condition.

The electronic device may generate multi-angle information of the target point, including at least the first target angle, the second target angle, and the third target angle. The electronic device may generate point cloud data, including range information, velocity information, and angle information, based on the multi-angle information of the target point. The electronic device may expand a single target point to points (or the points 14, 15, and 16) of the objects 2, 3, and 4 having different angle information.

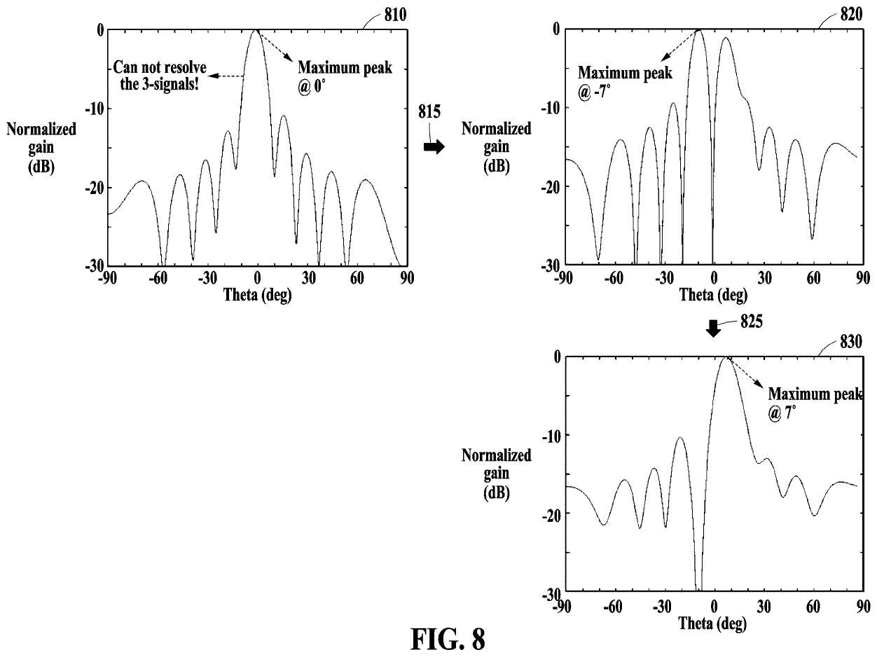

FIG. 8 illustrates example operations of methods of generating multi-angle information for a large object at a short range using a relatively low angular resolution radar sensor according to one or more embodiments

Referring to FIG. 8, in a non-limiting example, a process of generating multi-angle information for a large object at a short range if the radar sensor has a relatively low angular resolution is illustrated through manipulations of the input from the radar sensor as angular spectrum graphs 810, 820, and 830.

In an example, as illustrated in graph 810, the electronic device may generate an angular spectrum corresponding to a target point based on a radar signal received through the antenna array of the radar sensor. The electronic device may identify a first target angle 0° of a first peak signal corresponding to the first maximum peak if the first maximum peak of the angular spectrum corresponding to the target point satisfies the defined condition.

For example, if the radar sensor has an angular resolution of 10°, signals at 7° intervals, similar to graphs 610, 620, and 630 of FIG. 6, may not be readily distinguished from one another in the angular spectrum 810.

In an example, as illustrated in graph 820, an updated angular spectrum obtained through step 815 which may be performed by the electronic device subtracting a first target angular spectrum generated based on the first peak signal from the angular spectrum corresponding to the target point. The electronic device may identify a second target angle −7° of a second peak signal corresponding to the second maximum peak if the second maximum peak of the updated angular spectrum satisfies the defined condition.

In an example, as illustrated in graph 830, an updated angular spectrum obtained through step 825 which may be performed by the electronic device subtracting a second target angular spectrum generated based on the second peak signal from the updated angular spectrum 820. The electronic device may identify a third target angle 7° of a third peak signal corresponding to the third maximum peak if the third maximum peak of the angular spectrum updated again satisfies the defined condition.

The electronic device may generate multi-angle information of the target point, including at least the first target angle, the second target angle, and the third target angle. The electronic device may generate point cloud data, including range information, velocity information, and angle information, based on the multi-angle information of the target point. Even if the radar sensor has a relatively low angular resolution, the electronic device may expand the single target point of the large object 1 to the points 11, 12, and 13 having different angle information.

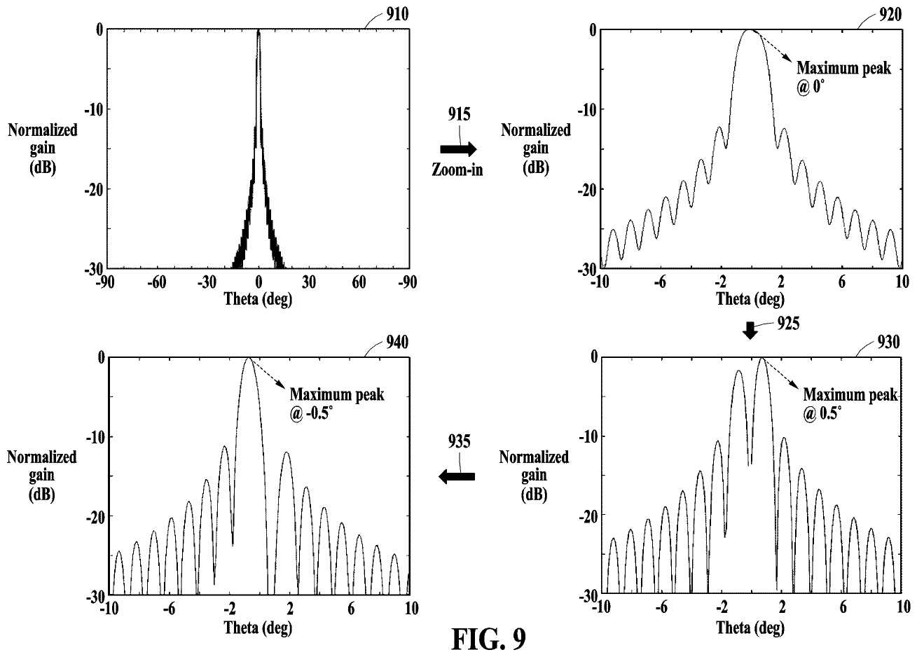

FIG. 9 illustrates example operations of methods of generating multi-angle information for an object at an extended range according to one or more embodiments.

Referring to FIG. 9, in a non-limiting example, a process of generating multi-angle information for an object at an extended range is illustrated through manipulations of the input from the radar sensor as angular spectrum graphs 910, 920, 930, and 940.

In an example, as illustrated in graph 910, the electronic device may generate an angular spectrum corresponding to a target point based on a radar signal received through the antenna array of the radar sensor.

If an object is at a long range from the radar sensor, different points of this object may be arranged at very small angular intervals relative to the radar sensor. For example, even if the radar sensor has a relatively high angular resolution of 1°, signals at 0.5° intervals for the object at a long range may not be readily distinguished from one another.

In an example, as illustrated in graph 920, a zoomed-in perspective of the angular spectrum of graph 910 may be obtained through a zoom-in operation 915 which may be performed by the electronic device. The electronic device may identify a first target angle 0° of a first peak signal corresponding to the first maximum peak if the first maximum peak of the angular spectrum corresponding to the target point satisfies the defined condition.

In an example, as illustrated in graph 930, an updated angular spectrum obtained through step 925 which may be performed by the electronic device subtracting a first target angular spectrum generated based on the first peak signal from the angular spectrum corresponding to the target point. The electronic device may identify a second target angle 0.5° of a second peak signal corresponding to the second maximum peak if the second maximum peak of the updated angular spectrum satisfies the defined condition.

In an example, as illustrated in graph 940, another updated angular spectrum obtained through step 935 which may be performed by the electronic device subtracting a second target angular spectrum generated based on the second peak signal from the updated angular spectrum 930. The electronic device may identify a third target angle −0.5° of a third peak signal corresponding to the third maximum peak if the third maximum peak of the angular spectrum updated again satisfies the defined condition.

The electronic device may generate multi-angle information of the target point, including at least the first target angle, the second target angle, and the third target angle. The electronic device may generate point cloud data, including range information, velocity information, and angle information, based on the multi-angle information of the target point. The electronic device may expand a single target point of the object to points having different angular information even if the object is at a super-long range from the radar sensor (or if multiple points are within an angular range smaller than the angular resolution of the radar sensor).

The electronic devices, vehicles, radar systems, sensors, vehicle 100, electronic device 120, radar sensor 130, electronic device 200, processor 210, memory 220, radar sensor 230, and antenna 240 described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating an angular spectrum corresponding to a target point, based on a radar signal received through an antenna array of a radar sensor;
identifying a target angle of a peak signal corresponding to a maximum peak responsive to a maximum peak of the angular spectrum satisfying a defined condition;
updating the angular spectrum by subtracting a target angular spectrum generated based on the peak signal from the angular spectrum; and
generating multi-angle information of the target point, the multi-angle information including one or more target angles, the generating the multi-angle information comprising:
iteratively performing additional identifying of the target angle and additional updating of the angular spectrum until an iteratively derived maximum peak of an iteratively updated angular spectrum does not satisfy the defined condition.

2. The method of claim 1, wherein the generating the angular spectrum comprises:
determining the target point by performing range fast Fourier transform (FFT) and Doppler FFT, based on the radar signal; and
generating the angular spectrum corresponding to the target point, based on the radar signal.

3. The method of claim 2, wherein the generating the angular spectrum comprises:
generating the angular spectrum corresponding to the target point by performing digital one or more of beamforming (DBF), averaged periodograms, and angle FFT, based on the radar signal.

4. The method of claim 1, wherein the updating the angular spectrum comprises:
generating the peak signal corresponding to the maximum peak, based on signal characteristics of the maximum peak;
generating the target angular spectrum, based on the peak signal; and
updating the angular spectrum by subtracting the target angular spectrum from the angular spectrum.

5. The method of claim 1, wherein the target point comprises range information and velocity information, and
wherein the method further comprises:
generating point cloud data comprising range information, velocity information, and angle information, based on the multi-angle information of the target point.

6. The method of claim 1, wherein the target point comprises a plurality of target points, and
wherein the method further comprises:
performing the generating the angular spectrum, the identifying the target angle, the updating the angular spectrum, and the generating the multi-angle information on each of the plurality of target points; and
generating point cloud data, based on multi-angle information of each of the plurality of target points.

7. The method of claim 1, wherein the generating the multi-angle information of the target point comprises:
generating, if a maximum peak of a latest updated angular spectrum does not satisfy the defined condition, the multi-angle information including the target angle and at least one additional target angle respectively identified from at least one updated angular spectrum being updated before a latest iteration of the iterative performing of the additional identifying and the additional updating.

8. The method of claim 1, wherein the defined condition comprises a condition where a radar cross-section (RCS) value represented by the maximum peak of the angular spectrum exceeds a threshold.

9. The method of claim 8, wherein the threshold is determined based on a minimum RCS value of a specified detected object.

10. The method of claim 9, wherein the threshold is further determined by applying a weight to the minimum RCS value.

11. An electronic device, comprising:
at least one processor comprising processing circuitry; and
memory comprising one or more storage media storing instructions that, when executed individually or collectively by the at least one processor, cause the electronic device to:
generate an angular spectrum corresponding to a target point, based on a radar signal received through an antenna array of a radar sensor,
identify a target angle of a peak signal corresponding to a maximum peak responsive to a maximum peak of the angular spectrum satisfying a defined condition, update the angular spectrum by subtracting a target angular spectrum generated based on the peak signal from the angular spectrum, and
generate multi-angle information of the target point, the multi-angle information including one or more target angles, the generating the multi-angle information comprising:
iteratively performing additional identifying of the target angle and additional updating of the angular spectrum until an iteratively derived maximum peak of an iteratively updated angular spectrum does not satisfy the defined condition.

12. The electronic device of claim 11, wherein the generating the angular spectrum corresponding to the target point, based on the radar signal received through the antenna array of the radar sensor, comprises:
determining the target point by performing range fast Fourier transform (FFT) and Doppler FFT, based on the radar signal; and
generating the angular spectrum corresponding to the target point, based on the radar signal.

13. The electronic device of claim 12, wherein the generating the angular spectrum comprises:
generating the angular spectrum corresponding to the target point by performing one or more of digital beamforming (DBF), averaged periodograms, and angle FFT, based on the radar signal.

14. The electronic device of claim 11, wherein the updating the angular spectrum comprises:
generating the peak signal corresponding to the maximum peak, based on signal characteristics of the maximum peak;
generating the target angular spectrum, based on the peak signal; and
updating the angular spectrum by subtracting the target angular spectrum from the angular spectrum.

15. The electronic device of claim 11, wherein the target point comprises range information and velocity information, and
wherein the instructions, when executed individually or collectively by the at least one processor, further cause the electronic device to:
generate point cloud data comprising range information, velocity information, and angle information, based on the multi-angle information of the target point.

16. The electronic device of claim 11, wherein the target point comprises a plurality of target points, and
instructions, when executed individually or collectively by the at least one processor, further cause the electronic device to:
perform the generating the angular spectrum, the identifying the target angle, the updating the angular spectrum, and the generating the multi-angle information on each of the plurality of target points, and
generate point cloud data, based on multi-angle information of each of the plurality of target points.

17. The electronic device of claim 11, wherein the generating the multi-angle information of the target point comprises:
generating, if a maximum peak of a latest updated angular spectrum does not satisfy the defined condition, the multi-angle information including the target angle and at least one additional target angle respectively identified from at least one updated angular spectrum being updated before a latest iteration of the iterative performing of the additional identifying and the additional updating.

18. The electronic device of claim 11, wherein a vehicle comprises the electronic device and the radar sensor.

19. The electronic device of claim 11, wherein the defined condition comprises a condition where a radar cross-section (RCS) value represented by the maximum peak of the angular spectrum exceeds a threshold.

20. The electronic device of claim 19, wherein the threshold is determined based on a minimum RCS value of a specified detected object.
